(19) United States
(12) Patent Application Publication
(10) Pub. No.: US 2026/0359717 A1
(43) Pub. Date: Nov. 12, 2026

(54) QUANTIZATION-AWARE TRANSFORMATION LAYERS IN MACHINE LEARNING MODELS

(71) Applicant: QUALCOMM Incorporated, San Diego, CA (US)

(72) Inventors: Boris VAN BREUGEL, Amsterdam (NL); Markus NAGEL, Amsterdam (NL); Yelysei BONDARENKO, Amsterdam (NL)

(21) Appl. No.: 19/204,385

(22) Filed: May 9, 2025

(51) Int. Cl. G06N 20/00

(52) U.S. Cl. CPC G06N 20/00

(57) ABSTRACT

Systems and techniques are described for integer quantization for one or more machine learning models. For example, a computing device can process, using quantized base model weights of a machine learning model, input data to generate output values. The computing device can generate activations based on normalized values from a normalization layer of a machine learning model; normalize a residual from a normalization layer; perform an elementwise multiplication on the normalized residual and the activations based on a scalar of the normalization layer to generate rescaled activations; and quantize weights of the machine learning model based on the rescaled activations to generate a quantized machine learning model.

### TECHNICAL FIELD

The disclosure relates generally to machine learning models. For example, aspects of the present disclosure include systems and techniques for configuring quantization-aware transformation layers in machine learning models.

### BACKGROUND

Machine learning systems (or models), such as neural networks (e.g., deep neural networks) are widely used for numerous applications, such as generative operations (e.g., to generate images, language/text outputs, etc.), object detection, object classification, object tracking, big data analysis, among others. For example, convolutional neural networks (CNNs) are able to extract high-level features, such as facial shapes, from an input image, and use these high-level features to output a probability that, for example, an input image includes a particular object.

A generative machine learning system can process data to generate desired output content from an input (e.g., a natural language input, input image(s) or video(s), a noise input such as for diffusion models, etc.). For instance, a language-based generative machine learning model (e.g., a large language model (LLM)) can generate natural language responses from natural language inputs and can incorporate various forms of data, such as audio, images and text. In some cases, a generative machine learning system can include an encoder that processes input features to generate output features (also referred to as embeddings or encodings) and can use the output features to generate relevant output content in a given form (e.g., in a natural language form, as generated images and/or video, as audio, explanation of the content, etc.).

A generative ML system can perform a wide range of tasks such as answering questions, providing explanations, generating creative content, assisting with coding, and offering recommendations. Various tools may be connected to the generative ML system to allow interaction with external systems, such as browsing the Internet, generating images, executing code, etc. Generative ML systems are designed to assist users in solving problems, learning new information, and enhancing productivity.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described herein for configuring machine learning models to generate content. According to at least one example, an apparatus is provided that includes one or more memories (e.g., configured to store data) and one or more processors (e.g., implemented in circuitry) coupled to the one or more memories and configured to:

In some aspects, an apparatus for configuring quantization-aware transformation layers in machine learning models is provided. The apparatus includes at least one memory and at least one processor coupled to the at least one memory and configured to: determine first weights associated with a first transformation of an input tensor of a trained machine learning model; determine second weights associated with an second transformation of an output tensor of the trained machine learning model; combine the first weights and the second weights with corresponding weights in the trained machine learning model to generate combined weights; and generate a quantized machine learning model based on the combined weights.

In some aspects, a method for configuring integer quantization for one or more machine learning models is provided. The method includes: determining first weights associated with a first transformation of an input tensor of a trained machine learning model; determining second weights associated with a second transformation of an output tensor of the trained machine learning model; combining the first weights and the second weights with corresponding weights in the trained machine learning model to generate combined weights; and generating a quantized machine learning model based on the combined weights.

In some aspects, a non-transitory computer-readable medium is provided having stored thereon instructions that, when executed by at least one processor, cause the at least one processor to: determine first weights associated with a first transformation of an input tensor of a trained machine learning model; determine second weights associated with an second transformation of an output tensor of the trained machine learning model; combine the first weights and the second weights with corresponding weights in the trained machine learning model to generate combined weights; and generate a quantized machine learning model based on the combined weights.

In some aspects, an apparatus for configuring quantization-aware transformation layers in machine learning models is provided. The apparatus includes: means for determining first weights associated with a first transformation of an input tensor of a trained machine learning model; means for determining second weights associated with a second transformation of an output tensor of the trained machine learning model; means for combining the first weights and the second weights with corresponding weights in the trained machine learning model to generate combined weights; and means for generating a quantized machine learning model based on the combined weights.

In some aspects, an apparatus for configuring quantization-aware transformation layers in machine learning models is provided. The apparatus includes at least one memory and at least one processor coupled to the at least one memory and configured to: generate activations based on normalized values from a normalization layer of a machine learning model; normalize a residual from a normalization layer; perform an elementwise multiplication on the normalized residual and the activations based on a scalar of the normalization layer to generate rescaled activations; and quantize weights of the machine learning model based on the rescaled activations to generate a quantized machine learning model.

In some aspects, a method for configuring integer quantization for one or more machine learning models (or machine learning systems) is provided. The method includes: generating activations based on normalized values from a normalization layer of a machine learning model; normalizing a residual from a normalization layer; performing an elementwise multiplication on the normalized residual and the activations based on a scalar of the normalization layer to generate rescaled activations; and quantizing weights of the machine learning model based on the rescaled activations to generate a quantized machine learning model.

In some aspects, a non-transitory computer-readable medium is provided having stored thereon instructions that, when executed by at least one processor, cause the at least one processor to: generate activations based on normalized values from a normalization layer of a machine learning model; normalize a residual from a normalization layer; perform an elementwise multiplication on the normalized residual and the activations based on a scalar of the normalization layer to generate rescaled activations; and quantize weights of the machine learning model based on the rescaled activations to generate a quantized machine learning model.

In some aspects, an apparatus for configuring quantization-aware transformation layers in machine learning models is provided. The apparatus includes: means for generating activations based on normalized values from a normalization layer of a machine learning model; means for normalizing a residual from a normalization layer; means for performing an elementwise multiplication on the normalized residual and the activations based on a scalar of the normalization layer to generate rescaled activations; means for and quantizing weights of the machine learning model based on the rescaled activations to generate a quantized machine learning model.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following drawing figures:

FIG. 1 illustrates an example implementation of a system, which may include a central processing unit (CPU), configured to perform one or more of the functions described herein;

FIG. 2 is a block diagram illustrating a multimodal generative machine learning system for generating natural language responses based on natural language input from a prompt and any additional information in accordance with aspects of the disclosure;

FIG. 3 is a block diagram illustrating a generative response engine in accordance with aspects of the disclosure;

FIG. 4 is a block diagram of at attention head of a generative response engine in accordance with some aspects of the disclosure;

FIG. 5A is a block diagram of an attention head including a quantization-aware transformation layer in accordance with some aspects of the disclosure;

FIG. 5B is a block diagram of an attention head including a trained quantization-aware transformation layer in accordance with some aspects of the disclosure;

FIG. 6A is a block diagram of another attention head including a quantization-aware transformation layer in accordance with some aspects of the disclosure;

FIG. 6B is a block diagram of another attention head including a trained quantization-aware transformation layer in accordance with some aspects of the disclosure;

FIG. 7 is a block diagram of an attention head including a quantization-aware transformation layer for a residual stream in accordance with some aspects of the disclosure;

FIG. 8 is a flow diagram illustrating an example of a process for configuring quantization-aware transformation layers in machine learning models, in accordance with aspects of the disclosure;

FIG. 9 is a flow diagram illustrating an example of a process for configuring quantization-aware transformation layers in machine learning models, in accordance with aspects of the disclosure;

FIG. 10 is a block diagram of an example transformer in accordance with some aspects of the disclosure; and

FIG. 11 shows an example of a computing system, which may be for example any computing device that may implement components of the system.

### DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

Machine learning models can be trained to perform various functions and/or provide various types of outputs. For instance, some generative machine learning models can provide a conversational interface that uses natural language prompts as inputs, such as text or voice. In some examples, a user can provide an input prompt in natural language to the generative machine learning model, and the generative machine learning model can provide a response in natural language form. The input prompt and the output response can optionally be combined with one or more other types of information or data, such as images or files.

Previously trained machine learning models (also referred to as machine learning systems), such as generative machine learning models, can be fine-tuned to improve performance of the machine learning models for specific tasks. Fine-tuning can involve adapting a pre-trained machine learning model (e.g., a pre-trained generative machine learning model or other type of machine learning model) to a specific task by updating parameters (e.g., weights and/or other parameters) of the machine learning model using task-specific training data. The fine-tuning process allows the machine learning model to leverage its pre-existing knowledge while specializing in new tasks. Fine-tuning typically requires less data and compute than fully training a previously untrained machine learning model. Fine-tuning can thus be useful for improving performance of machine learning models on domain-specific tasks without sacrificing the benefits of large-scale pretraining.

While machine learning models (e.g., neural networks) are powerful architectures capable of a wide range of useful tasks, such as recognizing objects in image data, they are likewise highly resource dependent. For example, neural networks may require significant compute, memory, power, and/or time resources for training and/or for inferencing. These resource requirements may significantly limit the ability to train and deploy neural networks to certain types of devices and for certain use cases. For instance, training of machine learning models may be a computationally intensive process that can take a relatively long time, a large quantity of training data, and many operations.

Quantization is a method of mapping continuous values to a smaller set of discrete finite values. For example, quantization approximates real-world values (e.g., floating point values) with representative values (e.g., integer values) that limit the precision and range of the original input. When applied to machine learning, such as to a neural network, quantization may significantly reduce resource usage for both training and inferencing. For example, performing massive numbers of integer operations during training of or inferencing with a quantized (e.g., reduced-precision) neural network may be significantly more efficient in terms of resource usage as compared to performing floating point operations with an unquantized (e.g., full-precision) neural network processing the same input data.

Quantization of trained machine learning models allows quantized trained machine learning models to be efficiently deployed on various devices. Quantization may allow a quantized trained machine learning model to perform operations (e.g., at the inference phase of operation) on a device relatively quickly. Quantization may include changing a format of parameters (e.g., weights and activations) of a machine learning model from the format in which the machine learning model was trained to a different format.

Post-Training Quantization (PTQ) is a process by which a trained machine learning model is quantized. For example, during training, a machine learning model may store parameters (e.g., weights) according to a first format that may allow a high degree of precision. For example, during training, the model may store parameters as floating-point numbers, such as 16-bit floating point numbers, which may be referred to as float16 or FP16, or 32-bit floating point numbers, which may be referred to as float32 or FP32. According to PTQ, after training is performed to generate the trained machine learning model and before the trained machine learning model is deployed onto a device for use by a device, the model may be quantized by, in part, changing the format used to store the parameters of the model from the first format to a second format (e.g., an integer format where the parameters are represented as integer numbers instead of floating point numbers). The second format may use less memory and/or be less computational expensive to use. For example, after quantization, the model may store parameters as integer numbers such as 16-bit integer numbers (which may be referred to as Int16), 8-bit integer numbers (which may be referred to as Int8), 4-bit integer numbers (which may be referred to as Int4), etc. It may be less computationally expensive to store and/or operate using integer numbers than floating point numbers. Thus, a device may conserve power and/or processing time when using a quantized trained machine learning model as compared with using an unquantized trained machine learning model. Accordingly, it may be advantageous to quantize machine learning models.

Quantized Aware Training (QAT) is another quantization technique that allows a machine learning model to adapt to quantization during training, resulting in better performance after actual quantization is performed as compared to quantizing a fully trained model (e.g., using PTQ). For example, using QAT, a machine learning model can be trained while simulating effects of actual quantization of weights and/or activations of the machine learning model during training. QAT can minimize accuracy loss when the machine learning model is eventually quantized to a different format, such as from floating point to an integer format, such as Int8.

In various aspects of the present disclosure, the term “quantize,” “quantizing,” and like terms may be used as a verb and may be applied to machine learning models, and/or layers of a trained machine learning model. In such cases the term “quantize,” “quantizing,” and like terms may refer to quantizing parameters (e.g., weights and/or activations) as stored in the of the respective machine learning models and/or layers. For example, a trained machine learning model may include weights (e.g., numerical values). During training, and after training, the weights may be stored in the trained machine learning model in a first format (e.g., float16). Quantizing the trained machine learning model may include changing the weights from the first format to a second format (e.g., Int8).

Further, machine learning models may include activations. Activations can refer to values used as inputs and/or outputs of various functions, operations, and/or layers (or blocks or modules) of the machine learning model. The activations may have a certain format. For example, a function (of a particular layer) may expect to receive values formatted according to the certain format. For instance, the function may read the values from memory according to the certain format. Further, the function may output other values (e.g., based on processing the values read from memory by the function) according to a particular format (which may or may not be the same as the certain format). For instance, the function may write the other values to memory in the particular format. For example, an unquantized trained machine learning model may use FP16 to pass values between functions (e.g., outputting values from one function and reading the values by another function). The activations of the machine learning model can also be quantized. For example, quantizing activations may refer to obtaining values calculated by a layer (e.g., an output of an activation function of the layer) and in the format of discrete values. For instance, the values may be represented with fewer bits, such as 8-bit or 16-bit integer numbers instead of 32-bit floating point numbers. After quantization of the activations the machine learning model is configured to process and/or output, the quantized trained machine learning model may use Int8 or Int16 to pass the values between functions. The term “quantize,” “quantizing,” and like terms may refer to changing how activations are stored and/or used in a quantized machine learning model.

Quantizing numbers can result in a loss of precision. Quantizing a trained machine learning model can result in degradation of the model. In the present disclosure, the term “noise” is used to describe a degree of difference between outputs of an unquantized trained machine learning model and the trained machine learning model after being quantized (given the same inputs). For example, a trained machine learning model may be quantized. The unquantized trained machine learning model may be provided an input, the quantized trained machine learning model may be provided the same input. Outputs of the models may be compared. A degree of difference between the outputs may be described as noise. Noise may be a way to describe degradation of a quantized machine learning model.

Not all elements of a neural network are equally resilient to quantization. That is, certain elements of a neural network may be more sensitive to quantization than others. Consequently, quantizing an entire neural network to a uniform bitwidth (referred to a fixed-precision quantization (FPQ)) may result in reduced resource usage, but may also reduce task performance to an unacceptable level (e.g., a high amount of noise or error). To resolve this issue, mixed-precision quantization (MPQ) seeks to quantize different elements (e.g., layers, blocks, modules, etc.) of a neural network at varying quantization rates based on different sensitivity levels of the different elements (e.g., a first layer having a first sensitivity quantized using Int8, a second layer having a second sensitivity quantized using Int16, etc.), which results in reduced resource usage while maintaining task performance. For example, lower sensitivity elements may be quantized using lower bit precision (e.g., using Int4 instead of Int8 or Int16) and higher sensitivity elements may be quantized using higher bit precision (e.g., using Int8 or Int16). The various elements of a neural network that may be quantized with MPQ include, for example, individual layers, groups of layers, sub-layers, weight channels, and others. Generally, MPQ can achieve higher accuracy for the same computational budget because it allocates higher precision to elements (e.g., layers) that are more sensitive to quantization and reduces bitwidth for elements more robust to quantization.

However, although MPQ techniques can be an effective technique for quantization, MPQ can create run-time challenges on hardware due to the need to convert from lower bit width representations to higher bit width representations, or vice versa, when performing operations (e.g., when performing matrix multiplication operations between values represented using different precision levels). Such conversions can result in negative performance impacts, such as increased latency and power consumption.

Systems, apparatuses, processes (also referred to as methods), and computer-readable media (collectively referred to as “systems and techniques”) are described herein for configuring quantization-aware transformation layers in machine learning models. For example, the systems and techniques can provide (e.g., generate) a quantized machine learning model using online transformations. In one or more implementations, one or more processors can determine and/or obtain first weights and second weights associated with different transformations applied to different outputs (e.g., activations output from layers and/or blocks, such as layers of an attention head) of a machine learning model. In some aspects, the first weights are associated with key weights and the second weights are associated with query weights. In some aspects, the first weights are associated with value weights the second weights are associated with an inversion of the value weights. The processor can combine the first and second weights with corresponding weights from the trained model to generate combined weights, and can generate a quantized version of the machine learning model based on the combined weights. In some cases, the resulting quantized model retains an equivalence to the original model while operating with lower precision representations (e.g., 8-bits integers).

In some aspects, the tensors associated with the first and second weights can be quantized, either prior to or during the quantization process of the machine learning model. The trainable transformation applied to the input tensor may include a structured matrix comprising scaling and rotation submatrices, each submatrix configured to modify specific subsets of channels within the input tensor. This design enables fine-grained control over how individual regions of the input space are transformed prior to quantization, allowing for more effective normalization and representation of outlier values.

In some aspects, the first and second weights are applied to components of the machine learning model such as attention blocks or other context-sensitive layers. The bit widths of weights in the quantized model can be reduced compared to the original trained model to improve memory compression and lower hardware compute requirements. The system may be configured to scale values that fall outside a standard range through transformations encoded in the first and second weight matrices. The scale operation can include adjustments to scaling factors associated with rotation submatrices. In some aspects, a transformation is inserted in a mathematically invertible manner in the machine learning model and the final output can remain unchanged when full precision (e.g., floating point precision) is used. In some aspects, during quantization, the transformation reshapes the distribution of the values to improve quantization before the values are downsampled to lower precisions (e.g., lower bit widths).

In some aspects, the one or more processors can convert the learned transformation weights from a floating-point representation to an integer format, consistent with a quantization strategy that ensures compatibility with integer-based inference hardware. Additionally, the system may be configured to process and quantize weights at one or more layers of the machine learning model, including base layers, such that final quantized base model weights reflect contributions from the trained transformations. In certain implementations, the base model weights of the machine learning model are modified by combining them with the first and second transformation weights, resulting in a unified and compressed model that maintains high inference accuracy while enabling efficient deployment.

Additional aspects of the present disclosure are described in more detail below. Various aspects of the systems and techniques described herein will be discussed below with respect to the figures.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

In some aspects, each of the apparatuses, computing devices, etc. described herein is, can be part of, or can include a mobile device (e.g., a mobile telephone or so-called “smart phone” or other mobile device), a vehicle or a component, device, or system of a vehicle, an extended reality (XR) device (e.g., a virtual reality (VR) device, an augmented reality (AR) device, or a mixed reality (MR) device), a wearable device, a smart or connected device (e.g., an Internet-of-Things (IoT) device), a camera system, a personal computer, a laptop computer, a tablet computer, a server computer, a robotics device or system, an aviation system, or other device. In some aspects, the apparatuses, computing devices, etc. may include one or more image sensors (e.g., camera(s)) for capturing one or more images. In some aspects, the apparatuses, computing devices, etc. may include one or more displays for displaying one or more images, notifications, and/or other displayable data. In some aspects, the apparatuses, computing devices, etc. may include one or more speakers, one or more light-emitting devices, one or more microphones, etc. In some aspects, the apparatuses, computing devices, etc. may include one or more sensors, such as one or more sensors used for determining a location of the apparatus(es), device(s), a state (e.g., a tracking state, an operating state, a temperature, a humidity level, and/or other state) of the of the apparatus(es), device(s), etc., and/or for other purposes.

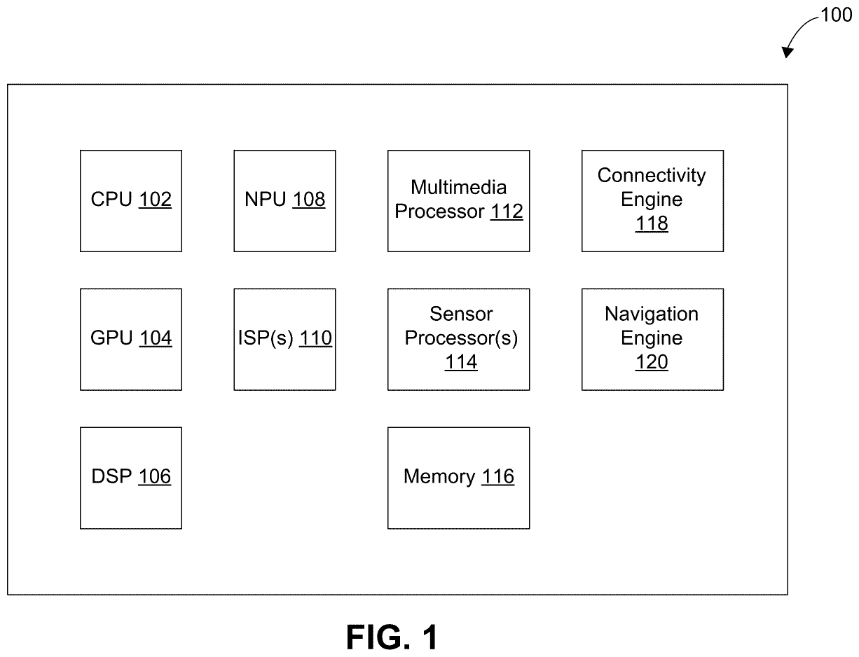

FIG. 1 illustrates an example implementation of a system 100, which may include a central processing unit (CPU), configured to perform one or more of the functions described herein. System 100, which may include a central processing unit (CPU 102) (which may be a multi-core CPU). Parameters or variables (e.g., neural signals and synaptic weights), system parameters associated with a computational device (e.g., neural network with weights), task information, among other information may be stored in a memory block associated with a neural processing unit (NPU 108), in a memory block associated with a CPU 102, in a memory block associated with a graphics processing unit (GPU 104), in a memory block associated with a digital signal processor (DSP 106), in a memory 116, and/or may be distributed across multiple blocks. Instructions executed at the CPU 102 may be loaded from a program memory associated with the CPU 102 or may be loaded from memory 116.

The system 100 may also include additional processing blocks tailored to specific functions, such as the GPU 104, the DSP 106, a connectivity engine 118, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU is implemented in the CPU 102, the DSP 106, and/or the GPU 104. The system 100 may also include one or more sensor processor(s) 114, one or more image signal processors (ISP(s) 110), and/or navigation engine 120, which may include a global positioning system. In some examples, the sensor processor(s) 114 can be associated with or connected to one or more sensors for providing sensor input(s) to the sensor processor(s) 114. For example, the one or more sensors and sensor processor(s) 114 can be provided in, coupled to, or otherwise associated with a same computing device.

The system 100 may be implemented as a system on a chip (SoC). The system 100 may be based on an Advanced Reduced Instruction Set Computer (RISC) Machine (ARM) instruction set. The system 100 and/or components thereof may be configured to perform machine learning techniques according to aspects of the present disclosure discussed herein. For example, the system 100 and/or components thereof may be configured to implement a machine learning model (e.g., a quantized trained machine learning model) as described herein and/or according to aspects of the present disclosure.

Machine learning (ML) can be considered a subset of artificial intelligence (AI). ML systems can include algorithms and statistical models that computer systems can use to perform various tasks by relying on patterns and inference, without the use of explicit instructions. One example of a ML system is a neural network (also referred to as an artificial neural network), which may include an interconnected group of artificial neurons (e.g., neuron models). Neural networks may be used for various applications and/or devices, such as image and/or video coding, image analysis and/or computer vision applications, Internet Protocol (IP) cameras, Internet of Things (IoT) devices, autonomous vehicles, service robots, among others.

Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer neural networks, diffusion-based neural networks, among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding this output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

Deep learning (DL) is one example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of a machine learning system, and can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

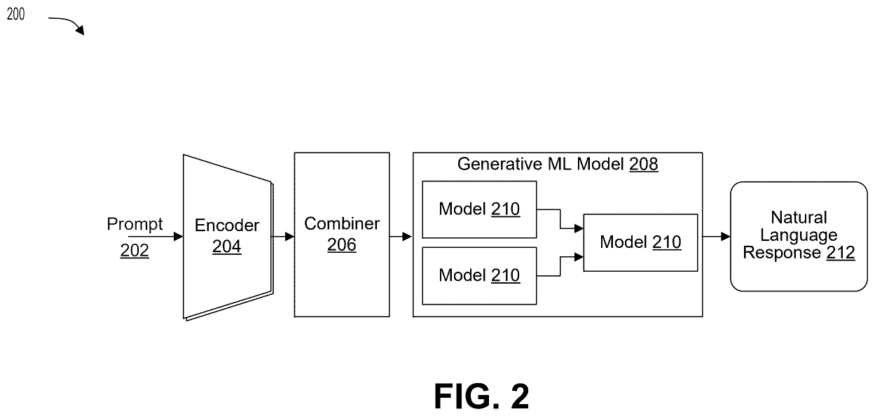

FIG. 2 is a block diagram illustrating a multimodal generative ML system 200 for generating natural language responses based on natural language input from a prompt 202 and any additional information. A multimodal machine learning system is a machine learning model that receives, processes, and outputs data in multiple forms. For example, the input prompt may include text, images, and audio.

For example, the multimodal generative ML system 200 includes a plurality of encoders 204 that are each configured to encode different modes of content (e.g., text, images, audio, etc.) into different tokens within a common embedding space. For example, a text input may be segmented based on different techniques (e.g., paragraph, sentence, etc.) and encoded by a text encoder (from the encoders 204) into tokens. In another example, one or more images can be provided to an image encoder (from the encoders 204) that extracts features associated with the image and generates tokens representing the visual features. In another example, audio can be provided to an audio encoder (from the encoders 204) that extracts features associated with the image and generates tokens representing the audio features. In the case of audio, the audio encoder can identify features that can include formants that characterize resonant frequencies in speech, rhythmic features related to timing and tempo, and harmonic features that describe the relationship between fundamental frequencies and their harmonics.

The different tokens from the plurality of encoders are provided to combiner 206. The combiner 206 can combine the tokens based on the order in which they are presented. For example, the input into the encoder may be an array of primitive values. A primitive value is an immutable data type provided by a programming language and includes values that represent a single piece of data (e.g., number, string, Boolean, etc.) rather than a complex object or reference. A non-limiting example prompt may include a byte array (e.g., an unsigned 8-byte integer array or uint8array), and another string. The byte array may be audio, images, or other content that can be processed by the encoders 204. In some aspects, the combiner 206 is configured to concatenate the different tokens in order based on the array to preserve the semantic order of features and provide the tokens to the generative machine learning model 208.

The generative machine learning model 208 is configured to receive the tokens and generate a natural language response 212 based on the tokens and the prompt 202. Generative machine learning model 208 may include one or more models 210 (e.g., transformer neural network(s), diffusion model(s), fully connected layer(s), multilayer perceptrons (MLPs), any combination thereof, and/or other models). The one or more models 210 of the generative machine learning model 208 are configured to process the tokens and extract different types of features that are relevant to the prompt 202. For example, the prompt 202 can be a query for a particular type of information. The one or more models of the generative machine learning model 208 can perform different tasks related to the query, such as writing code to perform a particular function, generating an image based on an input image with expressed modifications, generate an image without any input image, and so forth.

The generative machine learning model 208 may include different components, such as a featurization engine to identify different types of features, an inference engine to identify inferences within the text (e.g., pronoun usage and corresponding disambiguation functions), data retrieval engines (e.g., to identify features related to a particular concept observed by the generative machine learning model 208), and so forth. The generative machine learning model 208 may also include different types of models and engines to synthesize a coherent contextual output, such as to synthesize the input content and information that is responsive to tasks embedded within the text. For example, the generative machine learning model 208 may include a predictive output engine (not shown) that is configured to generate a sequence of words that is most likely contextually correct and to provide a coherent and contextually relevant answer. For instance, the predictive output generation engine can generate responses by sampling from the probability distribution of possible words and sequences based on patterns observed during training. The generative machine learning model 208 may also include a predictive output generation engine to generate multiple responses that are potentially relevant and coherent with respect to the prompt 202. The generative machine learning model 208 may also include an output validation engine configured to evaluate the generated responses based on certain criteria. Non-limiting examples of criteria to evaluate generated responses include relevance to the prompt, coherence, fluency, and adherence to specific guidelines or rules. Based on the evaluation, the output validation engine may select and output the most appropriate response.

As noted above, the generative machine learning model 208 may include various types of models (e.g., machine learning models), such as a transformer. A transformer is a neural network architecture that can be trained to perform one or more natural language processing (NLP) tasks, such as language translation, sentiment analysis, and text summarization. Conventional traditional recurrent neural networks (RNNs) process data in sequence. A transformer or transformer network can process input in parallel and can thus be faster and more efficient than sequential training and processing. In some aspects, a transformer can use a self-attention mechanism (e.g., one or more self-attention layers), which allows the transformer to identify the most relevant parts of the input text or content (e.g., audio or video). In some cases, a transformer can also use a cross-attention mechanism (e.g., one or more cross-attention layers) which uses other content or data to determine the most relevant parts of the input. For example, cross-attention mechanisms are useful in sequential content such as a stream of data, such as optical flow, and other computer vision techniques.

A transformer neural network can include a multi-layer encoder-decoder architecture. For instance, an encoder of the encoder-decoder architecture can receive text as input, convert the input text into a sequence of hidden representations, and capture the meaning of the text at different levels of abstraction. A decoder of the encoder-decoder architecture can then process the representations output from the decoder to generate an output sequence, such as a text translation or a summary. The encoder and decoder can be trained together using supervised learning, unsupervised learning, or a combination of supervised and unsupervised learning techniques, such as maximum likelihood estimation and self-supervised pretraining. Illustrative examples of transformer engines include a BERT model, a Text-to-Text Transfer Transformer (T5), biomedical BERT (BioBERT), scientific BERT (SciBERT), and the SPECTER model for document-level representation learning. In some aspects, multiple transformer engines may be used to generate different tokens.

In some aspects, the generative machine learning model 208 may be executed using a neural engine (or multiple neural engines) for on-device execution, such as a neural processing unit (NPU), a neural signal processor (NSP), a digital signal processor (DSP), any combination thereof, and/or other neural engine. The neural engine can include a plurality of neural processing cores that are configured to parallelize operations associated with neural networks. A neural processing core can include arrays of multiply-accumulate (MAC) units and specialized instructions that are optimized for matrix operations, such as convolution and matrix multiplication. The neural processing core can receive input data and perform matrix transformations and nonlinear activation functions to break down and parallelize matrix operations. The neural processing core can perform tasks such as inference (e.g., runtime operation of a machine learning model) or training of deep learning models. The neural processing core can accelerate tasks by parallelization of larger computations that can be performed in parallel (e.g., matrix operations associated with neural networks). For instance, the neural engine may perform computer vision tasks such as object recognition. In some cases, the neural engine can be implemented based on various ML libraries such as PyTorch, which interfaces with the compute unified device architecture (CUDA) to parallelize operations.

In some aspects, the generative machine learning model 208 may be a small generative model that has fewer parameters, fewer layers, fewer neurons, or a simpler architecture compared to larger models. A small generative model may not capture the full complexity of the underlying data distribution as effectively as larger models but can still be useful in scenarios where computational resources are limited or where a simpler model is sufficient for the task. Small generative models can also be easier to train and interpret, making them suitable for certain applications. For example, ChatGPT-3.5 has 175 billion parameters that results in a size of 1.4 Terabytes (TB) for a model implemented with double-precision floating point numbers. A smaller model may have a simpler architecture, use fewer parameters (e.g., 10 million), and use less precise numbers (e.g., single-precision floating point numbers) resulting in a size of 38 Megabytes (MB).

In addition, small models benefit from increased training based on local execution and data specific to a local device and a user of that local device. An additional benefit to small models is increased privacy because the information is not transmitted over the network and only relies on information requested by the user or usage at the local device.

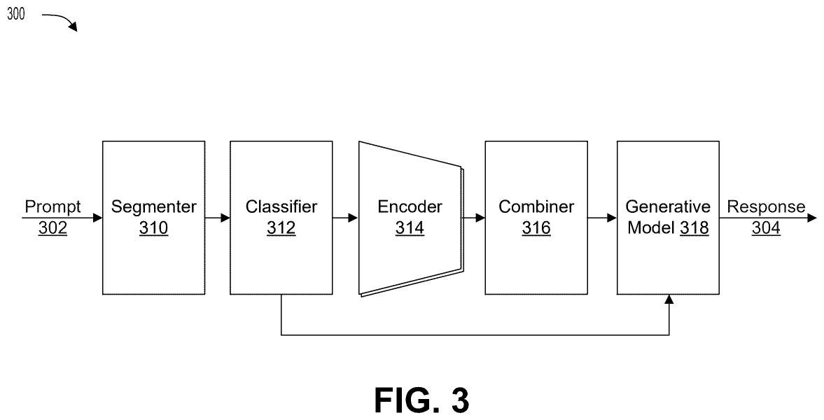

FIG. 3 is a conceptual block diagram of a generative response engine 300 that is configured for multimodal input and output in accordance with some aspects of the disclosure. In some aspects, the generative response engine 300 is configured to receive a prompt 302 (e.g., from a user, an application programming interface (API) request, etc.) and perform various processing to generate a response 304 that is responsive to the prompt 302 that is contextually accurate. In some aspects, the prompt 302 may be an array of primitive values, such as text, binary data (byte arrays, etc. For example, the prompt may be a union type that combines different types of primitive data (e.g., string uint8array in JavaScript).

The generative response engine 300 includes a generative machine learning model 318. In some aspects, the generative response engine 300 includes a plurality of adapters (e.g., LoRA) that are trained to improve performance of a base machine learning model (also referred to as a base model) of the generative response engine 300 during inference. The plurality of adapters can be trained to perform different tasks. For example, a first adapter may be trained to perform a first task, and a second adapter a second task and so forth. In this manner, the independently trained adapters are configured to prevent the generative response engine 300 from defaulting to the application of the base model's weights (which can be referred to as base model weights or base weights) and allow the combination of the base model and the adapters to accurately provide specialized responses that correspond to the fine tuning.

The generative response engine 300 includes various components, such as a segmenter 310, a classifier 312, a plurality of encoders 314, a combiner 316, and the generative machine learning model 318. The segmenter 310 is configured to segment different content into different portions based on various limitations, such as text size, image size, and so forth. In some cases, the segmenter 310 may also reduce the scope of content (e.g., by reducing a size of an input image) based on limitations of one or more machine learning models of the generative response engine 300. For example, the machine learning model(s) may be trained on a particular size input to extract important features. The segmenter 310 may also segment text into different chunks, such as into individual sentences or paragraphs.

In some aspects, the classifier 312 may be configured to classify the input. For example, the classifier 312 may be configured to generate embeddings that represent features associated with the input (e.g., segmented text, images, etc.) in a vector space. An embedding is a representation of a discrete object, such as a word, a document, or an image, as a continuous vector in a multi-dimensional space. An embedding captures the semantic or structural relationships between the objects, such that similar objects are mapped to nearby vectors, and dissimilar objects are mapped to distant vectors. Embeddings are commonly used in machine learning, computer vision, and natural language processing tasks, such as language modeling, sentiment analysis, and machine translation. Embeddings can be learned from large corpora of data using unsupervised learning algorithms, such as word2vec, GloVe, or fastText, which optimize the embeddings based on the co-occurrence or context of the objects in the data. Once learned, embeddings can be used to improve the performance of downstream tasks by providing a more meaningful and compact representation of the objects. In some aspects, the classifications are provided to the generative machine learning model 318 to activate specific learned domains.

In some cases, the classifier 312 may be configured to classify the input based on a plurality of clusters. The plurality of clusters may represent different semantic spaces for the operation of the generative response engine 300. The plurality of clusters may be related to different specialized tasks, data, or other operations and represent different domains of the generative response engine 300. For example, a generative model trained for customer service may need to learn different domains of knowledge, such as identification of products or services, accounting and billing information, a corpus of documents to help diagnose problems or provide information, and so forth. The plurality of clusters can be determined based on the input and output from the generative response engine 300.

In some cases, the classifier 312 may generate a probability for the prompt 302 (e.g., for each cluster) based on the output from the segmenter 310. The probability represents a likelihood that the prompt 302 is associated with features (e.g., features in a corresponding cluster). In some aspects, the classifier 312 provides the probabilities associated with each cluster and the embeddings to the generative machine learning model 318.

The segmented portions of the prompt 302 can then be provided as input to a plurality of encoders 314 (e.g., the encoders 204 in FIG. 2) to extract various features and generate tokens associated with those features. In some aspects, each encoder 314 is configured for a different modality or different type of input. For example, the generative response engine 300 may include an encoder 314 for encoding text, an encoder 314 for encoding images, an encoder 314 for encoding audio, etc. There may be additional encoders based on the different modalities. For example, there may be an encoder 314 for handling different types of documents (e.g., PDF, etc.).

The combiner 316 (e.g., the combiner 206 in FIG. 2) receives the tokens from the encoders 314 and synthesizes tokens that represent the prompt 302. For example, the combiner 316 can be configured to concatenate the tokens from the encoders 314 in the correct order to preserve the semantic context of the content. In some cases, the encoders 314 may be configured to execute the encoding operations in parallel and because different content may be encoded at different rates, the tokens may be received out of order. The combiner 316 may receive information (e.g., from the segmenter 310 and/or from the encoders 314) to identify how to sequence the embeddings into an input suitable for the generative machine learning model 318 (e.g., an array of tokens).

In some aspects, the generative machine learning model 318 is configured to use the embeddings during inference to begin inference operation based on the prompt 302. In some aspects, the probabilities from the classifier 312 can be used by the generative machine learning model 318 to activate at least one adapter based on the probability associated with that adapter. In some aspects, because the adapters are tuned independently based on clustered data, the adapters provide a stronger response based on the identification of features that more accurately represent that different classification.

The generative machine learning model 318 may be configured to synthesize the response 304 based on the probabilities provided by the classifier 312 and the generative machine learning model 318.

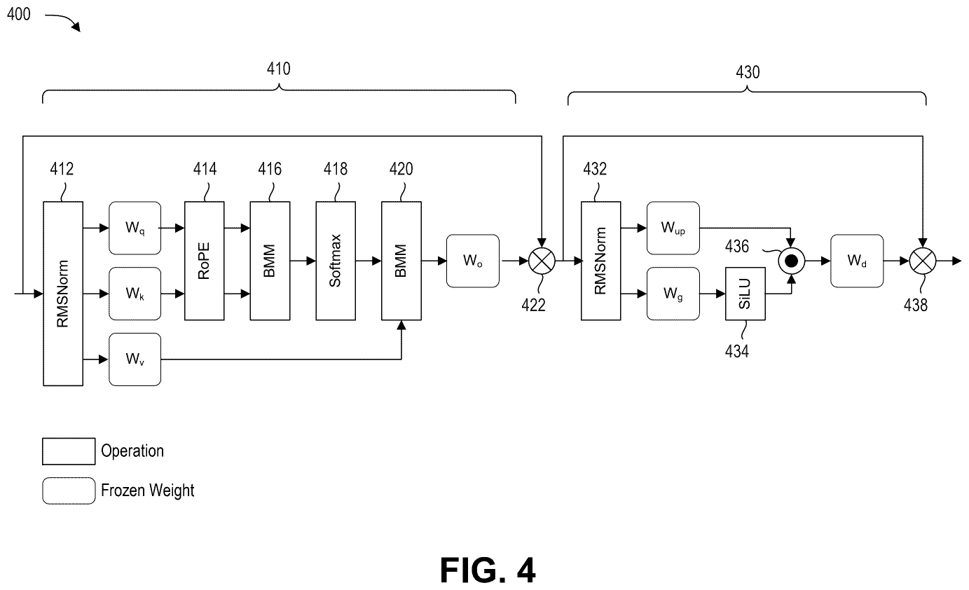

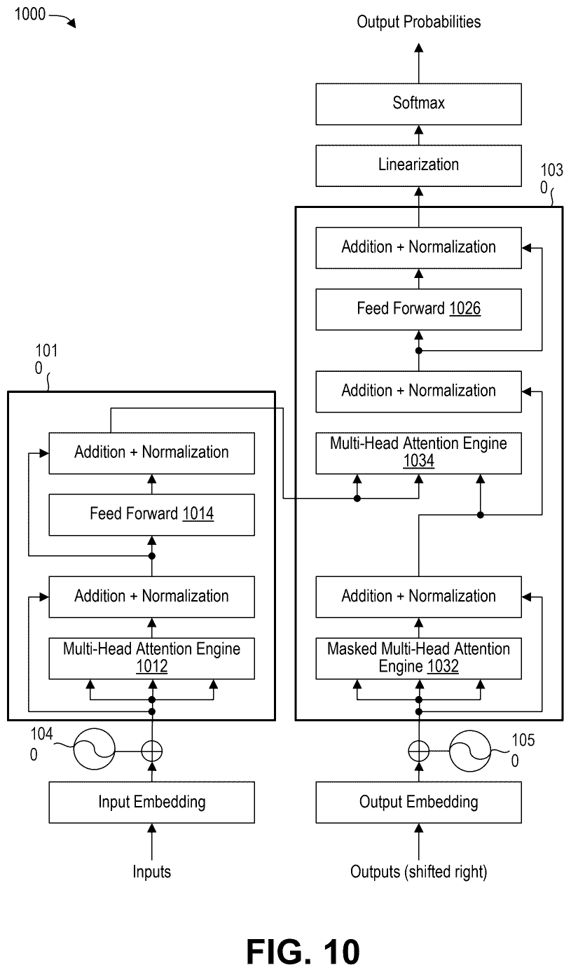

FIG. 4 is a block diagram of at attention head 400 of a generative response engine including an attention block 410 and a feedforward block 430. For example, the attention head 400 may be included in a transformer model (e.g., the transformer 1000 in FIG. 10). The attention head 400 is a self-attention mechanism and a feedforward network that is connected via residual paths and normalization layers. The attention module receives a source sequence of embeddings and perform an activation function based on multidimensional tensors (e.g., 4000 dimensions). An activation function in a neural network determines the output of a neuron by introducing non-linearity to enable the network to learn complex patterns.

The attention block 410 includes an initial normalization layer 412 (e.g. RMSNorm) configured to normalize the input data (e.g., embeddings) and prepare the data into a consistent, standardized format to standardize input, reduce noise and other variations. A multidimensional weight projection occurs after the initial normalization layer 412 and before a rotational position (RoPE) encoder. In some aspects, the multidimensional weight projection may be a tensor with each tensor weight is applied to the normalized value to creating different value matrices. For example, the query tensors, key tensors, and value tensors are generated based on the input tensors from the initial normalization layer 412.

During inference, the query, key, and value tensors are generated by multiplying the input tensor with the learned weight matrices Wq, Wk, and Wv, respectively. The weight matrices Wq, Wk, and Wv are frozen (e.g., fixed) after training and control the relative importance of different embedding components to learn and predict useful representations from the input data.

The weights are provided to the ROPE encoder 414 to embed relative position information into transformed queries and keys. The ROPE encoder 414 encodes positional information in sequences by rotating embeddings and generating rotary-embedded queries and keys. For example, Equation 1 below illustrates how each element is rotated, with n being the number of dimensions of the tensor.

$${T}_{q} = [ \begin{matrix}\begin{matrix}{w}_{1} cos {θ}_{1} & - {w}_{1} sin {θ}_{1} \\ {w}_{1} sin {θ}_{1} & {w}_{1} cos {θ}_{1}\end{matrix} & & \\ & \begin{matrix}{w}_{2} cos {θ}_{2} & - {w}_{2} sin {θ}_{2} \\ {w}_{2} sin {θ}_{2} & {w}_{2} cos {θ}_{2}\end{matrix} & \\ & & \begin{matrix}{w}_{n} cos {θ}_{n} & - {w}_{n} sin {θ}_{n} \\ {w}_{n} sin {θ}_{n} & {w}_{n} cos {θ}_{n}\end{matrix}\end{matrix} ] \qquad ( 1 )$$

The rotary-embedded queries and keys from the ROPE encoder are provided to batch matrix multiplication (BMM) 416 to perform a batch matrix multiplication and compute raw attention scores. For example, the BMM 416 performs a Hadamard element-wise multiplication between corresponding matrices in two batches, producing a batch of matrices where each entry is the product of the corresponding entries from the two input batches.

The attention scores are normalized using a softmax layer 418 to obtain attention weights. The attention weights are then applied to the activations produced by the value projection layer Wv in a second batch matrix multiplication in a second BMM 420 to generate an attention tensor.

The attention tensor is provided to an element-wise adder 422, which is a residual connection where the output of the attention block (e.g., the attention tensor) is added to the input tensor. The element-wise adder 422 is a standard residual addition (or residual connection) that allows gradient flow and preserves information.

In some cases, the self-attention mechanism helps by looking at surrounding different content (e.g., words, etc.) to assign contextual weights to all content in the sequence. Attention is still a linear transformation using weighted values and aggregates but does not deeply transform or reinterpret token representations. The feedforward block 430 following the attention block 410 applies a linear transformation to expand the representation space. For example, the feedforward block 430 learns complex transformation independently of attention and allows the learning and application of complex transformations. The self-attention mechanism helps by looking at surrounding words to assign contextual weights to all words in the sequence.

The feedforward block 430 includes a normalization layer 432 (e.g., RMSNorm) and the normalized tensor is input to the first feedforward projection Wff₁ (e.g., which can be a layer with frozen weights) that expands the dimensionality of the input into linear projections Wᵤₚ and W_{g}.

The linear projection W_{g} of the normalization layer 432 is passed through a non-linear activation function at a sigmoid linear unit 434. The sigmoid linear unit 434 can apply a swish transformation (e.g., using a Swish function) to improve expressiveness. For example, the Swish function is an activation function that can be used in neural networks to blend linear and non-linear behaviors and improve learning performance.

The linear projection Wᵤₚ and the and the expressed linear projection W_{g} can be combined using an element-wise product 436 (or other combining function) to introduce a gating mechanism. For example, the result of the sigmoid linear unit 434 (e.g., applying the swish transformation) can be element-wise multiplied with the linear projection Wᵤₚ output, effectively gating the information flow. The gated result can be projected into expressed projection W_{d} and added back to the input via an element-wise adder 438 (e.g., a second residual connection). In some aspects, gating can be performed using an activation function (e.g., a Gated Linear Unit (GLU), Swish-GLU (SwiGLU), etc.), which can enhance the expressiveness of the machine learning model by allowing dynamic control over feature activation.

The activated output can then be projected back to the original dimensionality using the second feedforward projection Wff₂ (e.g., which can be a layer with frozen weights). The element-wise adder 438 (as the second residual connection) adds the output W_{d} of the feedforward block 430 to the input (from the element-wise adder 422) of the feedforward block 430, maintaining the residual architecture that helps gradients flow during training.

In some aspects, the attention head 400 receives input token embeddings, which may be represented as multi-dimensional tensors encoding encoded tokens or words from a source sequence. The attention head processes these embeddings through a series of linear layers and matrix multiplications, resulting in a set of activation tensors. These activations are high-dimensional arrays comprising floating-point values, reflecting the intermediate computational state of the machine learning model as is continues processing tokens in the sequence. The computational relevance of activation tensors is significant. For each inference pass, the attention module generates a set of activations on the order of thousands or more per token. For example, the attention head 400 involves a high volume of floating-point operations (FLOPs), particularly during the computation of query-key dot products, softmax normalization, and weighted value aggregation. The core of the attention mechanism performs large-scale matrix multiplications (e.g., as Q·K^{T}Q and attention weights) grow quadratically with sequence length and linearly with model dimension. These operations are computationally intensive and require substantial memory bandwidth and parallel processing when using high-precision floating-point formats like FP32 or FP16.

As a result, the attention heads 400 consume significant power, particularly when executed on general-purpose processors or even GPUs. This high energy demand and latency make full-precision attention heads impractical for real-time or on-device inference where power efficiency and thermal constraints are important considerations. Techniques such as quantization, sparsity, or approximated attention mechanisms can be used adapt attention-based models for efficient on-device execution.

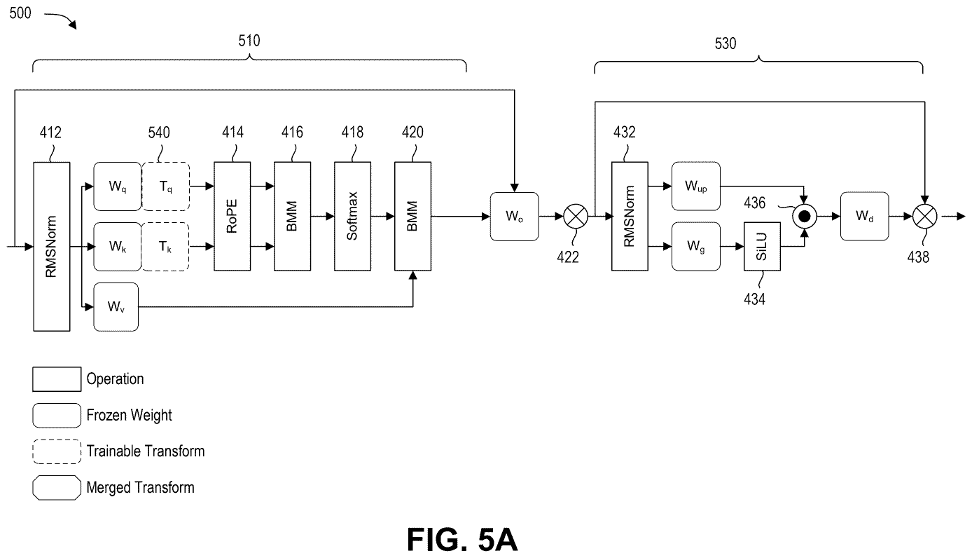

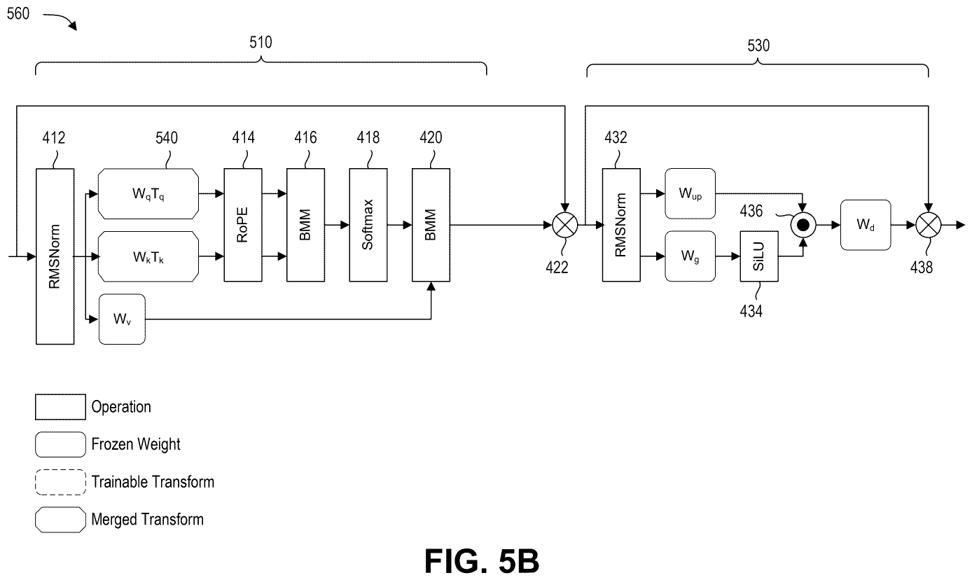

FIG. 5A is a block diagram of an attention head 500 including a quantization-aware transformation layer in accordance with some aspects of the disclosure.

In some aspects, the attention head 500 includes an attention block 510 and a feedforward block 530. The attention head 500 includes quantization (e.g., an online quantization) using a transformation 540 to address outliers in activations and weights. For example, the transformation can be represented by Q(X)Q(W)→Q(XT)Q(T⁻¹W). An outlier is a value in a dataset or tensor that is significantly larger or smaller than the other values and can adversely affect quantization accuracy. For example, certain channels or token positions in a tensor may produce extremely high values compared to the rest of the tensor. Outliers can create skew that causes major issues when using uniform quantization grids, which are designed to evenly span a range. If the grid is configured to accommodate a large outlier, the quantization grid becomes too coarse for values near zero, leading to substantial quantization error. Outlier tensors limit the ability to quantize to lower bit widths like 4-bit or 8-bit while preserving model accuracy.

In some aspects, the attention head 500 include a transformation 540 that is applied the input tensor to suppress or redistribute outliers. For example, the transformation 540 is learned during quantization to suppress or redistribute outliers. The transformation 540 can be structured as block-diagonal or rotation-scaling matrices to modify the scale and orientation of the tensor values in a controlled way. For example, a 2×2 rotation matrix may be applied per feature-pair block to allow selective scaling and rotation to reduce high-magnitude activations in particular channels. In other examples, the rotation matrix may be applied per feature-pair block to allow selective scaling and rotation to reduce high-magnitude activations in particular channels.

In some cases, the BMM 420 of the attention head 500 can invert the transformation 540 and ensure the transformation does not alter the final computation of the machine learning model. For example, the transformation T_{q} inverts the transformation applied by the transformation Tk at the BMM 420. The transformation 540 and the inverse transformation that is applied to the weights or to the output path can restore the original behavior of the machine learning model after quantization. For instance, if a transformation T is applied to an input X, and the machine learning model's weight is W, then the inverse transformation T⁻¹ is merged into W such that the effective operation becomes WₓT⁻¹(Tₓ)=Wₓ. In some aspects, quantization of the transformed weights can generate quantized values without changing the underlying model operations.

In some aspects, outliers are particularly damaging to static quantization schemes using a single quantization grid that can be shared across all tokens or channels. Without transformation, the presence one outlier can distort the entire grid and make the quantized machine learning model unfit for capturing fine-grained differences in the rest of the data. The transformation 540 and the inverse transformation redistribute values across blocks or dimensions, flatten the distribution, reduce the maximum magnitude seen by the quantizer to generate more efficient quantization grid that minimizes error for typical values while minimizing outliers.

In some aspects, the transformation 540 and the inverse transformation are trainable and initialized as identity matrices and during a post-training operation (e.g., fine-tuning or quantization-aware training), the transformation 540 and the inverse transformation are optimized to minimize quantization error. For example, a training system can generate loss values using [symbol] =∥W_{q}T_{q}∥ₚ+∥WₖTₖ∥ₚ and backpropagate to correct the loss. A training system may compare the output of a quantized model with the full-precision version and backpropagate the difference through the quantization and transformation layers. In some aspects, the post-training operation can be done per attention head to correct outliers that appear differently across heads and layers in the machine learning model.

In some aspects, after the transformation 540 has been trained, the transformation 540 is collapsed into a new weight matrix and modify the machine learning model parameters in-place. Merging the transformation 540 does not add extra operations at inference time and the quantized machine learning model behaves identically to the original machine learning model. In some aspects, the transformation 540 is inserted in a mathematically invertible manner and the final output can remain unchanged when full precision is used. In some aspects, during quantization, the transformation 540 reshapes the distribution of the values to improve quantization before the values are downsampled to lower precisions (e.g., lower bit widths).

FIG. 5B is a block diagram of an attention head 560 including a trained quantization-aware transformation layer in accordance with some aspects of the disclosure.

In some aspects, the transformation 540 occurs before rotary positional embedding and is applied to query and key matrices. In this case, outliers in these tensors propagate into the attention mechanism (e.g., via dot products in the softmax layer 418) and suppress outliers to prevent downstream amplification of error. The transformation 540 reduces quantization error in the most computationally expensive parts of the attention block 510 (e.g., such as matrix multiplications and softmax, etc.) without compromising numerical stability.

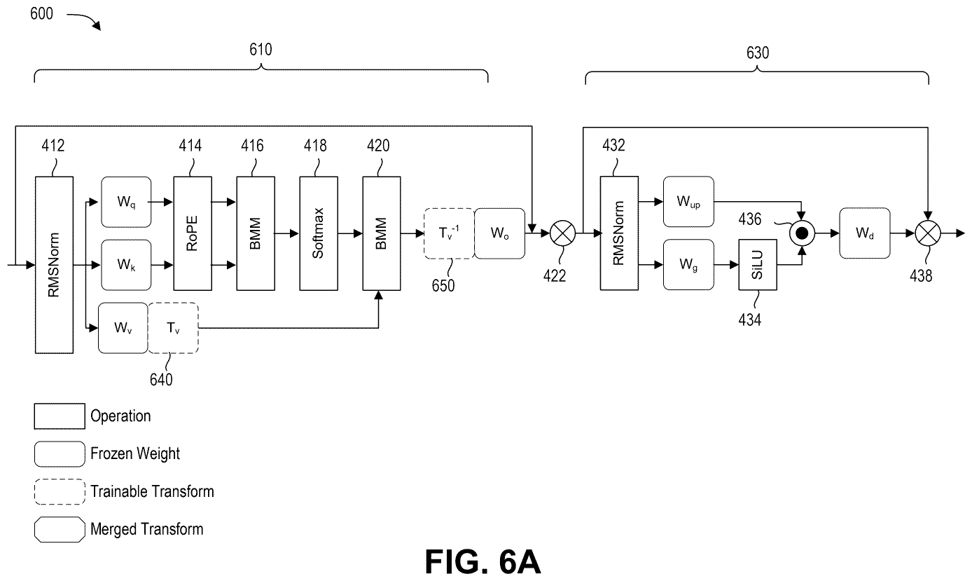

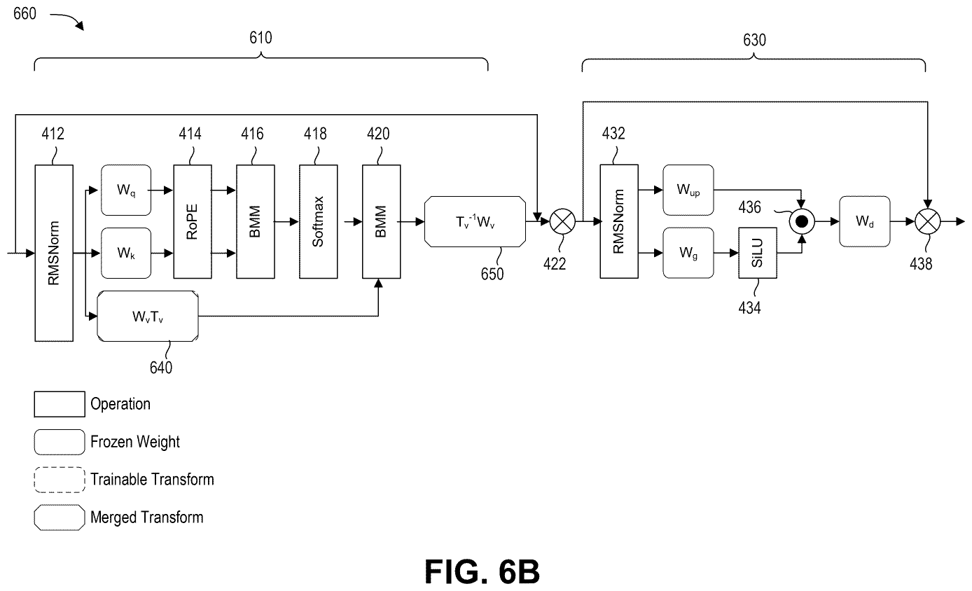

FIG. 6A is a block diagram of another attention head 600 including a quantization-aware transformation layer in accordance with some aspects of the disclosure.

The attention head 600 includes an attention block 610 and a feedforward block 630. The attention block 610 includes a transformation 640 and an inverse transformation 650 associated with a value matrix Wv. In some aspects, the transformation 640 (e.g., (Tᵥ) applied after the value projection, and the inverse Tᵥ⁻¹ is applied before the output projection. The attention head 600 applies the transformation to precondition the value vectors to reduce quantization sensitivity to outliers without changing the attention block 610. For example, the quantization between the transformation 640 and the inverse transformation 650 distributes or suppresses outlier activations to enable more accurate low-bit representations.

Instead of applying the transformations to the query matrix W_{q} and key matrix Wₖ, which affect the attention weights, the attention block 610 modifies the value matrix being aggregated without affecting the attention weights. In this case, the transformation 640 isolates the transformation to the part of the attention block 610 that directly influences the aggregated attention output and simplifies merging or optimization during in quantization-aware training.

The transformation 640 and the inverse transformation 650 are inserted in a mathematically invertible manner and the final output can remain unchanged when full precision is used. In some aspects, during quantization, the transformation 650 reshapes the distribution of the values to improve quantization before the values are downsampled to lower precisions (e.g., lower bit widths). For example, the inverse transformation 650 reshapes the distribution of the values to suppress large activation values. The transformation 640 preserves fidelity with reduced bit depth (e.g., precision) without a per-token dynamic quantization or per-layer tuning, while also preserving the attention weights.

In some aspects, the transformation 640 and the inverse transformation 650 are trainable and initialized as identity matrices and during a post-training operation (e.g., fine-tuning or quantization-aware training), the transformation 540 and the inverse transformation are optimized to minimize quantization error. For example, a training system can generate loss values using

$$ℒ = {‖ {W}_{v} {T}_{v} ‖}_{p} + {‖ {T}_{v}^{- 1} {W}_{o} ‖}_{p}$$

and backpropagate to correct the loss. A training system may compare the output of a quantized model with the full-precision version and backpropagate the difference through the quantization and transformation layers. In some aspects, the post-training operation can be done per attention head to correct outliers that appear differently across heads and layers in the machine learning model.

FIG. 6B is a block diagram of another attention head 660 including a trained quantization-aware transformation layer in accordance with some aspects of the disclosure. In some aspects, the transformation 640 and the inverse transformation 650 are merged with the weights of the tensor and do not incur a performance cost during inference.

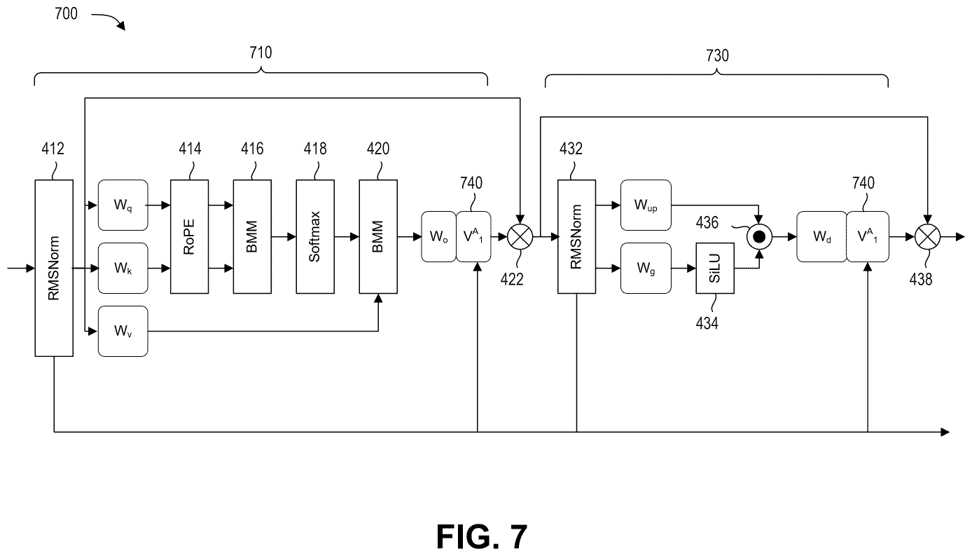

FIG. 7 is a block diagram of an attention head 700 including a quantization-aware transformation layer for a residual stream in accordance with some aspects of the disclosure. The residual stream is a path that carries the original input or intermediate activation forward across layers and allows the residual stream to be added back to the output of sublayers (e.g., the attention block 710, the feedforward block 730, etc.) to preserve information. Conventionally, residual connections in transformers are not normalized to preserve input information and stabilize training.

In some aspects, the attention head 700 is configured to dynamically scale residuals per token using normalizations derived from the normalization layer with a transformation 740. In some aspects, residual activation are unnormalized and can significantly vary between two adjacent tokens. The variance of the residual activations increase difficulty when combining output of the sublayers and make quantization difficult due to outliers.

In some aspects, the attention head 700 include a transformation 740 configured to normalize the residual stream per token using a scalar value. For example, the transformation 740 is configured to transform the accumulated activations passed between transformer layers. In some implementations, residual stream scaling differs from key/value quantization by targeting the accumulated activations passed between transformer layers, rather than the attention-specific projections used to compute alignment and context. Quantizing based on keys and values focuses on compressing the range of the inputs to the attention mechanism, which influence attention scores and output aggregation). Residual scaling is configured to maintain consistent scaling across tokens in the machine learning model, which can ensure a static quantization grid is effective without requiring dynamic adjustment at each layer. Residual quantization can be used to quantize the residual stream, denoted as \tilde{X}ₗ, without requiring dynamic adjustment at each layer.

In some aspects, the attention head 700 normalizes the residual stream and causes the difference between sequence elements to have smaller differences. In this case, the output of the BMM 416 has a different scale and a transformation 740 is included to match the magnitude of the normalized residual stream. For example, the transformation 740 causes the residual and any added values to be in the same magnitude range and significantly reduces the likelihood that outlier values dominate the distribution and cause quantization errors.

In some aspects, the transformation 740 is an element-wise multiplication and can compute a scalar from the normalized values from the initial normalization layer 412. For example, the output from the BMM 416 Yᵢ is scaled based on an element-wise multiplication \tilde{Y}ₗ=Vᵢ⊙Yᵢ, with Vᵢ being dimensions. This equation can be solved for the dimensions Vᵢ to show that a recursive relationship associated with the scalar and combination of the attention and feedforward blocks (e.g., MLP blocks) to show

$${V}_{i}^{M} = {V}_{i}^{M} \text{?} {‖ \text{?} ‖}_{R} ,$$

where \tilde{Z} represents the scaled combination of the output of the attention and feedforward blocks. In some aspects, the scalar ensures that differences between tokens are smoothed before quantization. In transformer machine learning models, outliers often manifest in certain tokens that diverge significantly from others, especially in long sequences or sparse representations. The transformation 740 scales each token individually and reduces the range of the residual stream across all tokens without requiring token-specific grids, which would introduce computational overhead and complexity. For example, in longer sequences (e.g., language modeling tasks), the computation of the residual stream grows with input length and quantizing the activations may require prohibitively wide grids or dynamic range detection per token.

In some aspects, the scalars associated with the transformation 740 are not learned and are computed based on the activations. The attention head 700 maintains the original architecture and performance of the machine learning model while enhancing compatibility with low-bit quantization. In some aspects, the transformation 740 is efficient and prevents rescaling based on the number of dimensions of each token.

The attention head 700 also scales across different layers. As outputs are passed through subsequent blocks, the scale needs to be preserved. In some aspects, the scale is managed recursively by propagating the scale factor from one block (e.g., an attention block 710) and combined with the next using element-wise multiplication. Propagating the scale factor ensures consistency throughout the machine learning model while still benefiting from the local normalization effect of the normalization of each layer. This causes the input into every block to remain within a predictable range and improves quantization reliability.

In some aspects, the transformation 740 is a linear transformation and the operations within the attention block 710 are also linear. In such aspects, due to the linearity, the placement of the transformation 740 is configurable. For example, the scaling can be applied after the second BMM 420 (to Wₒ) or after output projection. In such cases, the output of the machine learning model is unchanged and the final layers of the machine learning model re-normalize outputs (e.g., through a final RMSNorm or output layer) to neutralize the accumulated scaling effects. Using such techniques, the machine learning model changes do not affect (e.g., are “invisible” to) downstream applications and ensures backward compatibility with pretrained models. In some aspects, the machine learning model using the attention head 700 can be quantized more aggressively (e.g., to 4 or 8-bit precision) without degrading performance.

In some aspects, extreme outliers that interfere with quantization may also be further improved by optimizing each transformation locally and independently. For example, a training process using gradient descent can minimize the normalization of the transformed weights to compress the dynamic range and improve compatibility with quantization. Global transformations like rotations that impact multiple layers can be trained to minimize transformation for early projections (e.g., query, key, value, up, gate), and r later projections (e.g., output, down, gate). Layer-specific transformations can be trained such as the Pre-RoPE matrices. In some aspects, each transformation can be applied and merged into the model weights sequentially to reduce the impact of weight outliers on quantization.

In some aspects, the machine learning model can also be trained with a fine-tuning (e.g., a student-teacher training setup) to further reduce quantization error. For example, the full-precision model acts as the teacher, while the quantized model including the optimized transform is the student. The training minimizes divergence between the output distributions to ensure the quantized model closely matches the behavior of the original. In some cases, the fine-tuning also updates the quantization grid (e.g., scale and offset) to align the transformed activations.

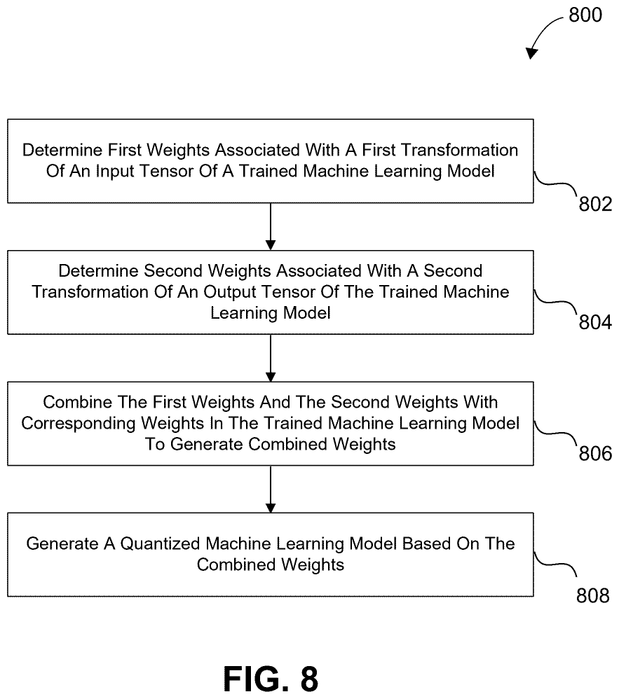

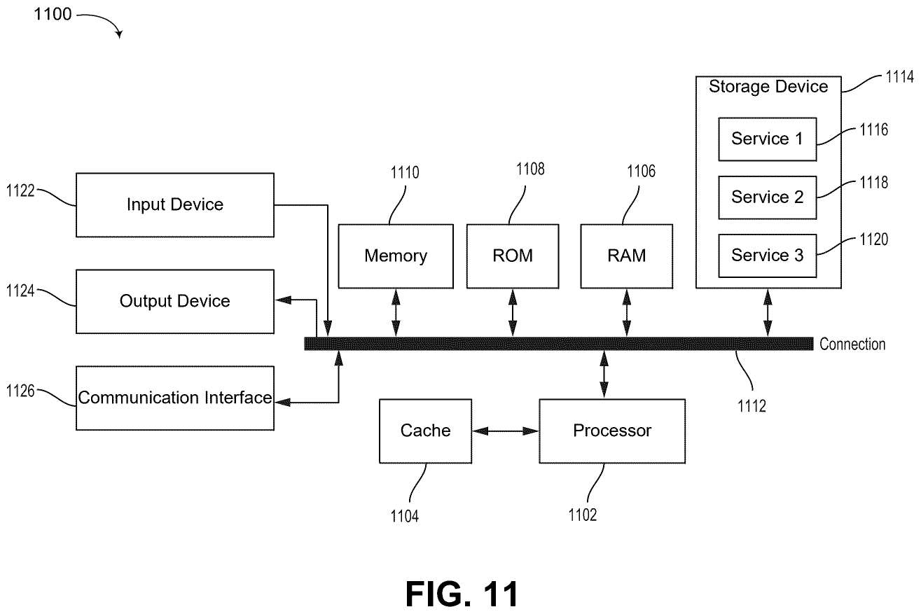

FIG. 8 is a flow diagram illustrating an example of a process for configuring adapters for machine learning models, in accordance with aspects of the disclosure. The process 800 (or any other described herein) can be performed by a computing device (or apparatus) or a component (e.g., one or more chipsets, a system-on-chip (SoC), one or more processors such as one or more central processing units (CPUs), graphics processing units (GPUs), digital signal processors (DSPs), neural processing units (NPUs), neural signal processors (NSPs), microcontrollers, ASICs, FPGAs, programmable logic devices, discrete gates or transistor logic components, discrete hardware components, etc., an ML system such as a neural network model, any combination thereof, and/or other component or system) of the computing device. The operations of the process 800 may be implemented as software components that are executed and run on one or more processors (e.g., CPU, GPU, DSP, NPU or neural engine, SoC, the processor 1102 of FIG. 11, and/or other processor(s)).

In some aspects, at block 802, the computing system may determine first weights associated with a trainable transformation of an input tensor of a trained machine learning model. For example, the trainable transformation comprises a matrix of scaling and rotation submatrices, and each submatrix configured to adjust values within a respective subset of channels of the input tensor. In one aspect, to determine the first weights and the second weights, the computing system may convert values combined with the first weights and the second weights from floating point format to integer format.

At block 804, the computing system may determine second weights associated with an inverse trainable transformation of an output tensor of the trained machine learning model. The first weights and the second weights are associated with an attention block. The first weights may be associated with key matrix and the second weights may be associated with a query matrix. In such aspects, the computing system may generate activations based on the combined weights and may use a ROPE layer (e.g., the ROPE encoder 414 of FIG. 4) to process the generated activations. In another aspect, the first weights are associated with a value matrix and the second weights are associated with an inverse of the value matrix.

At block 806, the computing system may combine the first weights and the second weights with corresponding weights in the trained machine learning model to generate combined weights.

At block 808, the computing system may combine the first weights and the second weights with corresponding weights in the trained machine learning model to generate combined weights. In one aspect, the computing system may quantize tensors associated with the first weights and tensors associated with the second weights. The bit widths of weights in the quantized machine learning model are less than bit widths of the trained machine learning model.

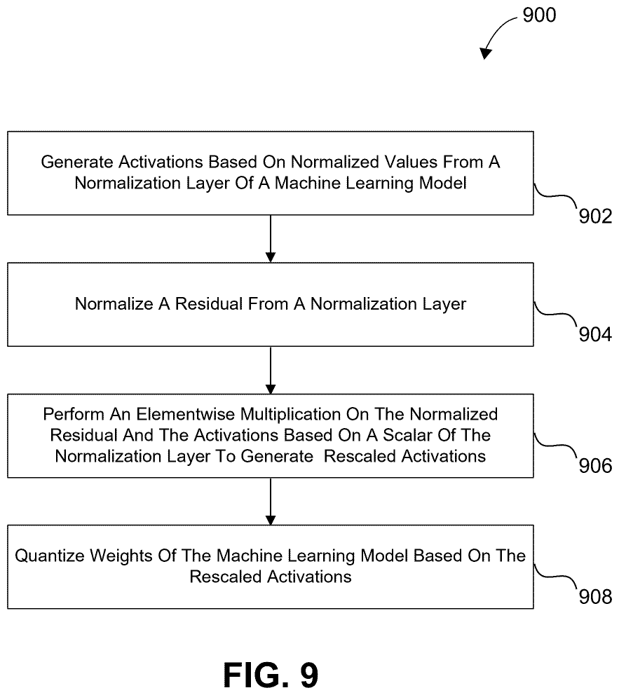

FIG. 9 is a flow diagram illustrating an example of a process for configuring adapters for machine learning models, in accordance with aspects of the disclosure. The process 800 (or any other described herein) can be performed by a computing device (or apparatus) or a component (e.g., one or more chipsets, a system-on-chip (SoC), one or more processors such as one or more central processing units (CPUs), graphics processing units (GPUs), digital signal processors (DSPs), neural processing units (NPUs), neural signal processors (NSPs), microcontrollers, ASICs, FPGAs, programmable logic devices, discrete gates or transistor logic components, discrete hardware components, etc., an ML system such as a neural network model, any combination thereof, and/or other component or system) of the computing device. The operations of the process 800 may be implemented as software components that are executed and run on one or more processors (e.g., CPU, GPU, DSP, NPU or neural engine, SoC, the processor 1102 of FIG. 11, and/or other processor(s)).

In some aspects, at block 902, the computing system may generate activations based on normalized values from a normalization layer of a machine learning model. For example, the activations are generated by a transformer block of the machine learning model.

At block 904, the computing system may normalize a residual from a normalization layer.

At block 906, the computing system may perform an elementwise multiplication on the normalized residual and the activations based on a scalar of the normalization layer to generate rescaled activations.

In some aspects, the computing system may provide the scalar of the normalization layer and the rescaled activations to a next layer. For example, the scalar is recursively propagated through the machine learning model to scale the residuals at each corresponding layer based on the value of the prior layer.

At block 908, the computing system may quantize weights of the machine learning model based on the rescaled activations to generate a quantized machine learning model.

In some aspects, the computing system may fine-tune the quantized machine learning model based on comparison of output of the quantized machine learning model and the machine learning model. For example, the quantized machine learning model and the original machine learning model can be used in a student-teacher configuration to fine tune the quantized model.

FIG. 10 is a block diagram of an example transformer in accordance with some aspects of the disclosure. In a convolutional neural network (CNN) model, the number of operations required to relate signals from two arbitrary input or output positions grows in the distance between positions, which makes learning dependencies at different distant positions challenging for a CNN model. The transformer 1000 reduces the operations of learning dependencies by using an encoder 1010 and a decoder 1030 that implements an attention mechanism at different positions of a single sequence to compute a representation of that sequence. An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key.

In one example of a transformer, the encoder 1010 is composed of a stack of six identical layers and each layer has two sub-layers. The first sub-layer is a multi-head self-attention engine 1012, and the second sub-layer is a fully connected feed-forward network 1014. A residual connection (not shown) connects around each of the sub-layers followed by normalization.

In this example of a transformer 1000, the decoder 1030 is also composed of a stack of six identical layers. The decoder also includes a masked multi-head self-attention engine 1032, a multi-head attention engine 1034 over the output of encoder 1010, and a fully connected feed-forward network 1026. Each layer includes a residual connection (not shown) around the layer, which is followed by layer normalization. The masked multi-head self-attention engine 1032 is masked to prevent positions from attending to subsequent positions and ensures that the predictions at position i can depend only on the known outputs at positions less than i (e.g., auto-regression).

In the transformer 1000, the queries, keys, and values are linearly projected by a multi-head attention engine into learned linear projects, and then attention is performed in parallel on each of the learned linear projects, which are concatenated and then projected into final values.

The transformer also includes a positional encoder 1040 to encode positions because the model does not contain recurrence and convolution and relative or absolute position of the tokens is needed. For example, the positional encodings are added to the input embeddings at the bottom layer of the encoder 1010 and the decoder 1030. The positional encodings are summed with the embeddings because the positional encodings and embeddings have the same dimensions. A corresponding position decoder 1050 is configured to decode the positions of the embeddings for the decoder 1030.

In some aspects, the transformer 1000 uses self-attention mechanisms to selectively weigh the importance of different parts of an input sequence during processing and allows the model to attend to different parts of the input sequence while generating the output. The input sequence is first embedded into vectors and then passed through multiple layers of self-attention and feed-forward networks. The transformer 1000 can process input sequences of variable length, making it well-suited for natural language processing tasks where input lengths can vary greatly. Additionally, the self-attention mechanism allows the transformer 1000 to capture long-range dependencies between words in the input sequence, which is difficult for RNNs and CNNs. The transformer with self-attention has achieved results in several natural language processing tasks that are beyond the capabilities of other neural networks and has become a popular choice for language and text applications. For example, the various large language models, such as a generative pretrained transformer (e.g., ChatGPT, etc.) and other current models are types of transformer networks.

FIG. 11 is a diagram illustrating an example of a system for implementing certain aspects of the present technology. In particular, FIG. 11 illustrates an example of a computing system 1100, which can be for example any computing device making up internal computing system, a remote computing system, a camera, or any component thereof in which the components of the system are in communication with each other using a connection 1112. The connection 1112 can be a physical connection using a bus, or a direct connection into the processor 1102, such as in a chipset architecture. The connection 1112 can also be a virtual connection, networked connection, or logical connection.

In some aspects, the computing system 1100 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

An example computing system 1100 includes at least one processing unit (a central processing unit (CPU) or processor) 1102 and a connection 1112 that couples various system components including a system memory 1110, such as ROM 1108 and RAM 1106 to the processor 1102. The computing system 1100 can include a cache 1104 of high-speed memory connected directly with, in close proximity to, or integrated as part of the processor 1102.

The processor 1102 can include any general purpose processor and a hardware service or software service, such as services 1116, 1118, and 1120 stored in the storage device 1114, configured to control the processor 1102 as well as a special-purpose processor where software instructions are incorporated into the actual processor design. The processor 1102 may essentially be a completely self-contained computing system, containing multiple cores or processors, a bus, memory controller, cache, etc. A multi-core processor may be symmetric or asymmetric.

To enable user interaction, the computing system 1100 includes an input device 1122, which can represent any number of input mechanisms, such as a microphone for speech, a touch-sensitive screen for gesture or graphical input, keyboard, mouse, motion input, speech, etc. The computing system 1100 can also include an output device 1124, which can be one or more of a number of output mechanisms. In some instances, multimodal systems can enable a user to provide multiple types of input/output to communicate with the computing system 1100. The computing system 1100 can include communications interface 1126, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 802.11 WiFi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1126 may also include one or more Global Navigation Satellite System (GNSS) receivers or transceivers that are used to determine a location of the computing system 1100 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

The storage device 1114 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another IC chip/card, RAM, static RAM (SRAM), dynamic RAM (DRAM), ROM, programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1114 can include software services, servers, services, etc., that when the code that defines such software is executed by the processor 1102, it causes the system to perform a function. In some aspects, a hardware service that performs a particular function can include the software component stored in a computer-readable medium in connection with the necessary hardware components, such as the processor 1102, the connection 1112, the output device 1124, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some examples, the processes described herein (e.g., process 800, process 900, and/or other process described herein) may be performed by a computing device or apparatus. In one example, the process 800 and process 900 can be performed by a computing device having a computing architecture of the computing system 1100 shown in FIG. 11.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. An apparatus for configuring integer quantization for one or more machine learning models, comprising: at least one memory; and at least one processor coupled to the at least one memory and configured to: determine first weights associated with a first transformation of an input tensor of a trained machine learning model; determine second weights associated with an second transformation of an output tensor of the trained machine learning model; combine the first weights and the second weights with corresponding weights in the trained machine learning model to generate combined weights; and generate a quantized machine learning model based on the combined weights.

Aspect 2. The apparatus of Aspect 1, wherein the at least one processor is further configured to: quantize tensors associated with the first weights and tensors associated with the second weights.

Aspect 3. The apparatus of any of Aspects 1 to 2, wherein the first transformation comprises a matrix of scaling and rotation submatrices, and wherein each submatrix configured to adjust values within a respective subset of channels of the input tensor.

Aspect 4. The apparatus of any of Aspects 1 to 3, wherein the first weights and the second weights are associated with a key matrix and a query matrix or a value matrix and an inversion of the value matrix.

Aspect 5. The apparatus of any of Aspects 1 to 4, wherein bit widths of weights in the quantized machine learning model are less than bit widths of the trained machine learning model.

Aspect 6. The apparatus of any of Aspects 1 to 5, wherein the first weights and the second weights are configured to scale outlier values that are outside of a value range.

Aspect 7. The apparatus of any of Aspects 1 to 6, wherein, to determine the first weights, the at least one processor is configured to: adjust a scalar value and an angle value of scaling and rotation submatrices.

Aspect 8. The apparatus of any of Aspects 1 to 7, wherein, to determine the first weights and the second weights, the at least one processor is configured to convert values combined with the first weights and the second weights from floating point format to integer format.

Aspect 9. The apparatus of any of Aspects 1 to 8, wherein the at least one processor is configured to process weights associated with at least one layer of the trained machine learning model to generate quantized base model weights.

Aspect 10. The apparatus of any of Aspects 1 to 9, wherein the at least one processor is configured to: generate activations based on the combined weights; and process the activations using a rotary position embedding (RoPE) layer.

Aspect 11. A method for configuring integer quantization for one or more machine learning models, comprising: determining first weights associated with a first transformation of an input tensor of a trained machine learning model; determining second weights associated with a second transformation of an output tensor of the trained machine learning model; combining the first weights and the second weights with corresponding weights in the trained machine learning model to generate combined weights; and generating a quantized machine learning model based on the combined weights.

Aspect 12. The method of Aspect 11, further comprising: quantize tensors associated with the first weights and tensors associated with the second weights.

Aspect 13. The method of any of Aspects 11 to 12, wherein the first transformation comprises a matrix of scaling and rotation submatrices, and wherein each submatrix configured to adjust values within a respective subset of channels of the input tensor.

Aspect 14. The method of any of Aspects 11 to 13, wherein the first weights and the second weights are associated with a key matrix and a query matrix or a value matrix and an inversion of the value matrix.

Aspect 15. The method of any of Aspects 11 to 14, wherein bit widths of weights in the quantized machine learning model are less than bit widths of the trained machine learning model.

Aspect 16. The method of any of Aspects 11 to 15, wherein the first weights and the second weights are configured to scale outlier values that are outside of a value range.

Aspect 17. The method of any of Aspects 11 to 16, further comprising: adjusting a scalar value and an angle value of scaling and rotation submatrices.

Aspect 18. The method of any of Aspects 11 to 17, further comprising: converting values combined with the first weights and the second weights from floating point format to integer format.

Aspect 19. The method of any of Aspects 11 to 18, further comprising: processing weights associated with at least one layer of the trained machine learning model to generate quantized base model weights.

Aspect 20. The method of any of Aspects 11 to 19, further comprising: generating activations based on the combined weights; and processing the activations using a rotary position embedding (RoPE) layer.

Aspect 21. An apparatus for configuring integer quantization for one or more machine learning models, comprising: at least one memory; and at least one processor coupled to the at least one memory and configured to: generate activations based on normalized values from a normalization layer of a machine learning model; normalize a residual from a normalization layer; perform an elementwise multiplication on the normalized residual and the activations based on a scalar of the normalization layer to generate rescaled activations; and quantize weights of the machine learning model based on the rescaled activations to generate a quantized machine learning model.

Aspect 22. The apparatus of Aspect 21, wherein the activations are generated by a transformer block of the machine learning model.

Aspect 23. The apparatus of any of Aspects 21 to 22, wherein the at least one processor is further configured to: provide the scalar of the normalization layer and the rescaled activations to a next layer.

Aspect 24. The apparatus of any of Aspects 21 to 23, wherein the at least one processor is further configured to: recursively propagate scalars through layers to scale residuals at each corresponding layer.

Aspect 25. The apparatus of any of Aspects 21 to 24, wherein the at least one processor is further configured to: fine-tune the quantized machine learning model based on comparison of output of the quantized machine learning model and the machine learning model.

Aspect 26. A method for configuring integer quantization for one or more machine learning models, comprising: generating activations based on normalized values from a normalization layer of a machine learning model; normalizing a residual from a normalization layer; performing an elementwise multiplication on the normalized residual and the activations based on a scalar of the normalization layer to generate rescaled activations; and quantizing weights of the machine learning model based on the rescaled activations to generate a quantized machine learning model.

Aspect 27. The method of Aspect 26, wherein the activations are generated by a transformer block of the machine learning model.

Aspect 28. The method of any of Aspects 26 to 27, further comprising: providing the scalar of the normalization layer and the rescaled activations to a next layer.

Aspect 29. The method of any of Aspects 26 to 28, further comprising: recursively propagating scalars through layers to scale residuals at each corresponding layer.

Aspect 30. The method of any of Aspects 26 to 29, further comprising: fine-tuning the quantized machine learning model based on comparison of output of the quantized machine learning model and the machine learning model.

Aspect 31. A non-transitory computer-readable medium having stored thereon instructions that, when executed by at least one processor, cause the at least one processor to perform operations according to any of Aspects 11 to 20.

Aspect 32. An apparatus for configuring integer quantization for one or more machine learning models, comprising one or more means for performing operations according to any of Aspects 11 to 20.

Aspect 33. A non-transitory computer-readable medium having stored thereon instructions that, when executed by at least one processor, cause the at least one processor to perform operations according to any of Aspects 26 to 30.

Aspect 34. An apparatus for integer quantization for one or more machine learning models, comprising one or more means for performing operations according to any of Aspects 26 to 30.

What is claimed is:

1. An apparatus for integer quantization for one or more machine learning models, comprising:
at least one memory; and
at least one processor coupled to the at least one memory and configured to:
determine first weights associated with a first transformation of an input tensor of a trained machine learning model;
determine second weights associated with a second transformation of an output tensor of the trained machine learning model;
combine the first weights and the second weights with corresponding weights in the trained machine learning model to generate combined weights; and
generate a quantized machine learning model based on the combined weights.

2. The apparatus of claim 1, wherein the at least one processor is further configured to:
quantize tensors associated with the first weights and tensors associated with the second weights.

3. The apparatus of claim 1, wherein the first transformation and the second transformation comprises a matrix of scaling and rotation submatrices, and wherein each submatrix configured to adjust values within a respective subset of channels of the input tensor.

4. The apparatus of claim 1, wherein the first weights and the second weights are associated with a key matrix and a query matrix or a value matrix and an inversion of the value matrix.

5. The apparatus of claim 1, wherein bit widths of weights in the quantized machine learning model are less than bit widths of the trained machine learning model.

6. The apparatus of claim 1, wherein the first weights and the second weights are configured to scale outlier values that are outside of a value range.

7. The apparatus of claim 1, wherein, to determine the first weights, the at least one processor is configured to:
adjust a scalar value and an angle value of scaling and rotation submatrices.

8. The apparatus of claim 1, wherein, to determine the first weights and the second weights, the at least one processor is configured to convert values combined with the first weights and the second weights from floating point format to integer format.

9. The apparatus of claim 1, wherein the at least one processor is configured to process weights associated with at least one layer of the trained machine learning model to generate quantized base model weights.

10. The apparatus of claim 1, wherein the at least one processor is configured to:
generate activations based on the combined weights; and
process the activations using a rotary position embedding (RoPE) layer.

11. An apparatus for integer quantization for one or more machine learning models, comprising:
at least one memory; and
at least one processor coupled to the at least one memory and configured to:
generate activations based on normalized values from a normalization layer of a machine learning model;
normalize a residual from a normalization layer;
perform an elementwise multiplication on the normalized residual and the activations based on a scalar of the normalization layer to generate rescaled activations; and
quantize weights of the machine learning model based on the rescaled activations to generate a quantized machine learning model.

12. The apparatus of claim 11, wherein the activations are generated by a transformer block of the machine learning model.

13. The apparatus of claim 11, wherein the at least one processor is further configured to:
provide the scalar of the normalization layer and the rescaled activations to a next layer.

14. The apparatus of claim 11, wherein the at least one processor is further configured to:
recursively propagate scalars through layers to scale residuals at each corresponding layer.

15. The apparatus of claim 11, wherein the at least one processor is further configured to:
fine-tune the quantized machine learning model based on comparison of output of the quantized machine learning model and the machine learning model.

16. A method of integer quantization for one or more machine learning models, comprising:
generating activations based on normalized values from a normalization layer of a machine learning model;
normalizing a residual from a normalization layer;
performing an elementwise multiplication on the normalized residual and the activations based on a scalar of the normalization layer to generate rescaled activations; and
quantizing weights of the machine learning model based on the rescaled activations to generate a quantized machine learning model.

17. The method of claim 16, wherein the activations are generated by a transformer block of the machine learning model.

18. The method of claim 16, further comprising:
providing the scalar of the normalization layer and the rescaled activations to a next layer.

19. The method of claim 16, further comprising:
recursively propagating scalars through layers to scale residuals at each corresponding layer.

20. The method of claim 16, further comprising:
fine-tuning the quantized machine learning model based on comparison of output of the quantized machine learning model and the machine learning model.
